(19) United States
(12) Patent Application Publication
(10) Pub. No.: US 2011/0114795 A1
(43) Pub. Date: May 19, 2011

(54) Aerodynamic Flap and Wing

(75) Inventors: Timo Voss, Hamburg (DE); Klaus Bender, Hamburg (DE)

(73) Assignee: Airbus Operations GmbH, Hamburg (DE)

(21) Appl. No.: 13/054,105

(22) PCT Filed: Jul. 14, 2009
(86) PCT No.: PCT/EP09/05121

§ 371 Date: Jan. 14, 2011

Related U.S. Application Data
(60) Provisional application No. 61/080,356, filed on Jul. 14, 2008.

(30) Foreign Application Priority Data
Jul. 14, 2008 (DE) 10 2008 033 005.1

(51) Int. Cl. B64C 3/50; B64C 23/06

(52) U.S. Cl. 244/213

(57) ABSTRACT

An aerodynamic flap with an articulation device to form an axis of rotation for purposes of a rotatable mounting of the aerodynamic flap on a wing section or structural section, with the flap coupled to the wing section in accordance with its intended purpose, with a front flap section situated upstream of the axis of rotation, as viewed in the flow direction, with a front edge line, and a rear flap section situated behind the axis of rotation, wherein a multiplicity of extension pieces are arranged on the front flap section, distributed over the span width of the flap, whose ends project beyond the front edge line of the flap as exposed parts, as viewed from the axis of rotation, wherein the extension pieces are rigid and arranged on the flap, such that one surface of the extension pieces forms an aerodynamically uniform surface with the upper or lower side of the flap, and such that when the flap is deflected the exposed ends of the extension pieces on one surface of the flap are directed at an angle against the flow to generate vortices, and in a neutral position of the flap are situated underneath the boundary layer of the wing, as well as a wing with such an aerodynamic flap.

### CROSS REFERENCE TO RELATED APPLICATIONS

This application claims priority to PCT Application No. PCT/EP2009/005121, filed Jul. 14, 2009; which claims priority to German Patent Application No. DE 10 2008 033 005.1, filed Jul. 14, 2008, and claims the benefit to U.S. Provisional Patent Application No. 61/080,356, filed Jul. 14, 2008, the entire disclosures of which applications are hereby incorporated by reference.

### BACKGROUND

U.S. Pat. No. 5,253,828 discloses a flap which is coupled to the main wing at the trailing edge of the main wing. At the leading edge of the flap vortex generators are disposed which have the shape of a plate and which project as fin-like elements from the flap

### SUMMARY OF THE INVENTION

This object is achieved with the features of the one or more embodiments disclosed and described herein. Further forms and other embodiments are also disclosed and described herein.

The invention concerns an aerodynamic flap and a wing.

Movable flaps or rudders on the trailing and leading edges of wings and/or tail assemblies are used for purposes of increasing the lift, the down force or the side force, such as e.g. as in a tail assembly. Here by the deflection of the movable flap or the rudder the curvature of the wing and/or of the tail assembly on what is, with this deflection, the concave side of the flap or the rudder is increased, and thus the circulation flow is strengthened. The strengthened circulation effects, as a function of its direction, an increase of the lift, the down force, or the side force. As a rule there is a linear relationship between flap deflection and additional lift, down force, or side force. This mode of operation can be of advantage, in particular with regard to the use of control surfaces, since the linear effect occurring from the deflection of the same can be better processed by pilots, or also the control system.

Regulating flaps can be arranged on the main wing in various ways and with different functions. Landing flaps can arranged on the main wing such that the surfaces of the main wing and the landing flap together form what is essentially a continuous curvature, or such that a gap occurs between the main wing and the particular position of the landing flap, through which energy can be supplied to the flow. Furthermore additional regulating flaps such as, in particular, spoilers, can be provided upstream of a landing flap on the main wing; in particular these can be lowered from a neutral position. By the lowering of such a regulating flap, or spoiler, upstream of a downwards deflected landing flap the increase in curvature for the wing is in total greater and is also distributed over a greater length and as a result more continuously, as viewed in the chordwise direction of the wing. Such regulating flaps, or spoilers exert what is again essentially an approximately linear aerodynamic effect.

With too large a deflection of such regulating flaps the flow over the curvature discontinuity is so strongly accelerated that the boundary layer can become unstable and can separate. Here the result is a gradual reduction of the effectiveness of the particular regulating flap and therefore a reduction of the lift, down force or side force. This effect leads to a non-linear effectiveness of the particular regulating flap. This effect is in particular of disadvantage in the use of regulating flaps that are provided as control flaps. When regulating flaps are used as landing flaps separation of the flow leads to lift saturation and with increasing flap deflection to an increase in drag of the whole wing. To avoid these unfavourable non-linearities, the deflection angle of regulating flaps is limited, and in most applications to about 30 degrees.

The maximum deflection angle of landing flaps and the accompanying increase in lift can be increased by the provision as described of continuous wing curvature, or one gap between the main wing and regulating flap, or two gaps situated one behind another in the flow direction for purposes of supplying flow energy and delaying the separation of the flow from the wing. For such flaps, however, a relatively complex and consequently also a heavy system of kinematics has to be provided with a large number of components that can move relative to one another.

In the case of regulating flaps, in particular as spoilers provided as lowerable control surfaces upstream of a landing flap, there is a maximum angle of lowering, beyond which the curvature discontinuity is too severe, as a result of which boundary layer separations can occur.

U.S. Pat. No. 4,039,161 A1 describes the use of adjustable vortex generators on a regulating flap, which are arranged ahead of the axis of rotation of the regulating flap, and thus ahead of the curvature discontinuity, for purposes of supplying flow energy into the boundary layer and for purposes of delaying flow separation.

From US 2007/0018056 A1 it is of known art to attach vortex generators in the form of a small flap that in each case can be folded out from the upper flow surface of a regulating flap.

In these solutions, however, the vortex generators also generate drag if enrichment of the energy in the boundary layer is not required, in particular, in other words, if the regulating flap is located in its neutral position. Furthermore in the technical implementation of these solutions additional moving parts and corresponding actuators are required, as a result of which additional weight must be tolerated. As a result of such kinematic and actuator systems solutions of this kind are also complex, which in particular make necessary additional control and monitoring functions.

Furthermore it is of known art from U.S. Pat. No. 5,088,665 A1 to design the trailing edge of a main wing, and/or of a flap that is coupled to it, with a saw tooth-type profile.

The object of the invention is to provide a regulating flap to be coupled to an aerodynamic wing, and a wing with such a regulating flap, whose maximum angle of deflection can be relatively large so that the occurrence of a relatively large curvature discontinuity arising as a result of the deflection of the regulating flap is permissible whilst avoiding disadvantageous boundary layer separations on the wing.

This object is achieved with the features of the independent claims. Further forms of embodiment are specified in the subsidiary claims that are dependent on the independent claims.

A flap or a wing with the features in accordance with the invention effects, by means of a suitable generation of vortices, the stabilisation of the aerodynamic boundary layer of the wing in deflected states of the flap, even when these take up a large angle of deflection, without the flap generating additional drag in its neutral position. The latter is achieved in that the flap in accordance with the invention does not have any additional attachments, which in the neutral position of the flap are situated underneath the boundary layer and thus are not exposed to the flow present on the wing in accordance with specification. In accordance with the invention additional flap sections or extension pieces for purposes of vortex generation are provided on the leading edge of the flaps, rigidly attached to the flap and aerodynamically effective in the deflected positions of the flap. In what follows the additional flap sections or extension pieces are therefore also called vortex generators.

The flap sections or extension pieces rigidly attached to the flap can as a matter of principle have different shapes and dimensions that are adapted to the particular application. In the deflected state of the flap an exchange of energy takes place between the mainstream flow around the wing and its boundary layer flow, as a result of which the latter is stabilised and flow separations are delayed. If the flap sections or extension pieces are exposed to the flow by the pivoting of the flap as described, as a result of the orientation of the flap sections or extension pieces at an angle to the flow direction a lift force thus forms on the flap sections or extension pieces, which in turn implies the formation of cone-shaped tip vortices along the triangular leading edges, and also in the further development downstream. These contra-rotating vortices effect the desired mixing of the boundary layer with the mainstream flow as described. By this means an exchange of energy takes place between the mainstream flow and boundary layer flow, as a result of which the latter is stabilised and flow separations are delayed.

With the flap 1 in accordance with the invention or the wing F in accordance with the invention the utilisable range of flap angles, e.g. for control surfaces and landing flaps, can be increased, without the need for complex kinematic systems. With small flap angles and in a neutral flap position the generation of additional drag is avoided. By this means the control surfaces or the wing can be reduced in size, which as a result of the thereby linked reduction in drag leads to an increase in aircraft efficiency. Compared with a conventional arrangement of wing and landing flap, or wing surface and control surface, the system features just a negligible additional complexity. Here one can assume a neutral influence on the weight.

In accordance with the invention an aerodynamic flap is provided with an articulation device to form an axis of rotation for purposes of a rotatable coupling of the aerodynamic flap to a wing section or structural section. With the flap coupled to the main wing in accordance with its intended purpose the flap has a front flap section with a front edge line situated in front of the axis of rotation, as viewed in the flow direction, and a rear flap section situated behind the axis of rotation, and also on the front flap section a multiplicity of extension pieces distributed over the width of the flap span, whose ends project as exposed parts beyond the front edge line of the flap, as viewed from the axis of rotation. In accordance with the invention the extension pieces are rigid and arranged on the flap such that one surface of the extension pieces forms an aerodynamically uniform surface with the upper or lower side of the flap, and such that when the flap is deflected the exposed ends of the extension pieces on one surface of the flap are directed at an angle against the flow to generate vortices, and in a neutral position of the flap are situated underneath the boundary layer of the wing.

The extension pieces can in particular be distributed at regular intervals over the width of the flap span. The exposed ends of the extension pieces can be designed in various ways and in particular as triangular, rectangular or round sections.

Furthermore in accordance with the invention a wing with a main wing and such an aerodynamic flap is provided, which on its front flap section has a multiplicity of extension pieces distributed over the width of the flap span, whose ends project beyond the front edge line of the flap as exposed parts, as viewed from the axis of rotation. In particular the extension pieces are arranged on the flap such that one surface of the extension pieces forms an aerodynamically uniform surface with the upper or lower side of the flap, and such that when the flap is deflected the exposed ends of the extension pieces on one surface of the flap are directed at an angle against the flow to generate vortices, and in a neutral position of the flap are situated underneath the boundary layer of the wing.

The extension pieces can be arranged on the flap such that in the neutral position of the flap they do not generate any swirl in the flow.

In the examples of embodiment in accordance with the invention provision can be made that the rear edge line of the main wing, at its rear running along the flap in the spanwise direction, runs such that the edge region of the main wing determined by the edge line has alternating extension pieces and recesses.

Furthermore in the examples of embodiment in accordance with the invention provision can be made that the flap overlaps the edge region of the main wing determined by the rear edge line of the main wing, as viewed against the flow direction. Alternatively or additionally in the examples of embodiment in accordance with the invention provision can be made that the edge region of the main wing determined by the outer contour of the rear edge line of the main wing interacts in a form fit manner with the outer contour of the flap facing towards the main wing, at least when the flap is located in its neutral position.

In accordance with the invention is to be understood by flap or aerodynamic flap any type of adjustable and aerodynamically effective flap arranged on a wing, or a main wing, or a structural component exposed to the flow. Such a flap can, in particular, be a spoiler, a landing flap, a control flap, or a rudder, such as e.g. a lateral rudder.

As a wing, in the context of this description, is to be understood any type of aerodynamic body. In this context the wing can, in particular, be the wing assembly or the vertical tail assembly of an aircraft.

### BRIEF DESCRIPTION OF THE DRAWINGS

In what follows examples of embodiment of the invention are described in terms of the accompanying figures, where:

FIG. 1 shows a perspective representation of a form of embodiment of the aerodynamic flap provided in accordance with the invention with an articulation device to form an axis of rotation for purposes of a rotatable mounting of the aerodynamic flap on a wing section or structural section,

FIG. 2 shows a lateral section of the form of embodiment of the aerodynamic flap in accordance with FIG. 1,

FIG. 3 shows a lateral section of the form of embodiment of the aerodynamic flap in accordance with FIG. 1 in a position deflected relative to a reference line,

FIG. 4 shows a perspective representation of a further form of embodiment of the aerodynamic flap provided in accordance with the invention with an articulation device to form an axis of rotation for purposes of a rotatable mounting of the aerodynamic flap on a wing section or structural section,

FIG. 5 shows a lateral section of the form of embodiment of the aerodynamic flap in accordance with the section line V-V of FIG. 4,

FIG. 6 shows a perspective representation of a form of embodiment of the wing provided in accordance with the invention with a main wing and an aerodynamic flap that is hinged to the main wing by means of an articulation device, wherein at least in the neutral position of the flap the edges or contours of the main wing and flap facing towards each other engage with one another in a form fit,

FIG. 7 shows a perspective representation of a form of embodiment of the main wing, whose edge contour facing towards the flap in accordance with the representation of FIG. 6 is configured such that it engages together with the edge contour of the flap facing towards it in a form fit.

### DETAILED DESCRIPTION OF THE INVENTION

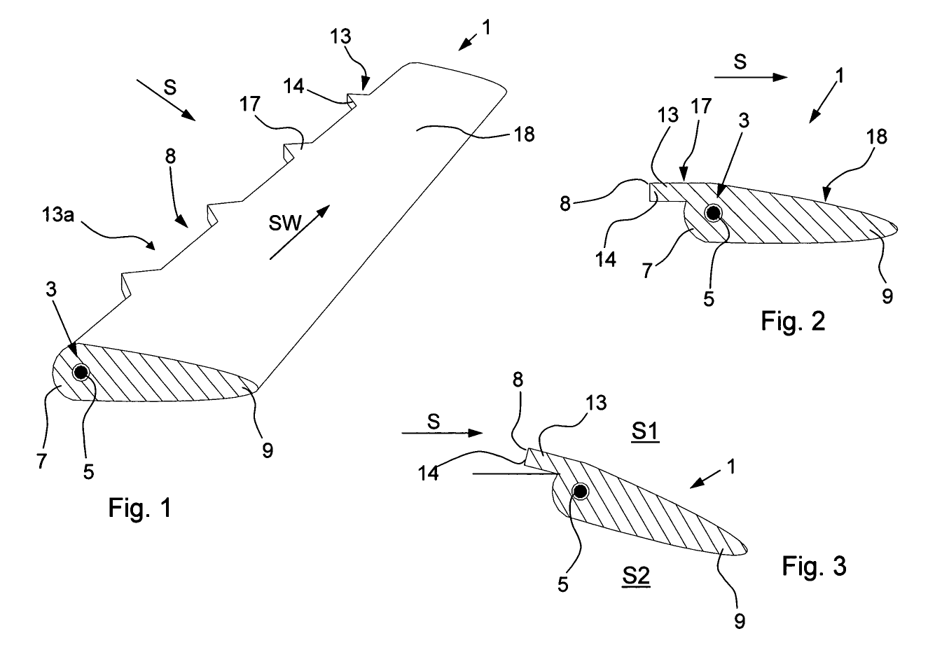

The form of embodiment of the aerodynamic flap provided in accordance with the invention shown in FIGS. 1 to 3 has an articulation device 3 to form an axis of rotation 5 for purposes of a rotatable mounting of the aerodynamic flap 1 on a wing section 10 or structural section. The wing section 10 can in particular be the main wing 10 of a wing assembly of an aircraft and in general of a wing F. With the flap 1 coupled in accordance with its intended purpose, with a front flap section 7 situated upstream of the axis of rotation 5, as viewed in the flow direction S, with a front edge line 8, and a rear flap section 9 situated behind the axis of rotation. On the front flap section 7 is arranged a multiplicity of extension pieces or extension sections 13 distributed over the width of the flap span, whose ends 14 project beyond the front edge line 7a of the flap as exposed parts, as viewed from the axis of rotation. The extension pieces 13 are rigid and arranged on the flap 1 such that one surface 16 of the extension pieces 13 forms an aerodynamically uniform surface with the upper side 18 or the lower side of the flap, and such that when the flap is deflected the exposed ends 13 of the extension pieces 14 on or along one surface 17 of the wing F or the flap 1 are directed at an angle against the flow direction S to generate vortices, and in a neutral position of the flap 1 are situated underneath the boundary layer of the wing F.

As represented in FIG. 1, the extension pieces 13 can be distributed at regular intervals over the width of the span of the flap 1, or at regular intervals in the spanwise direction SW of the flap 1. The example of embodiment of the flap 1 represented in FIG. 1 has four extension pieces 13. In accordance with the invention at least two extension pieces 13 are arranged on the front flap section 7. The exposed ends of the extension pieces 13 can, as represented in FIG. 1, have a triangular shape, or also another shape. For example, the extension pieces 13 can be designed as rectangular-shaped or round sections. If e.g. a triangular-shaped surface is exposed to the flow by the pivoting action as described, a lift force is formed on the vortex generator as a result of the orientation to the flow direction, which in turn implies the formation of cone-shaped tip vortices along the leading edge of the triangle, and also in the further development downstream. These contra-rotating vortices, or vortices rotating in opposite directions, effect the desired mixing of the boundary layer with the mainstream flow as described.

The extension pieces 13 can be attached as individual parts to the flap 1, or can be designed integrally with the flap 1, or a shell element of the same. In particular the extension pieces 13 can be manufactured integrally with the flap 1 or a shell element of the same.

With the flap coupled in accordance with an example of embodiment of the invention to a main wing 10 of a wing, the front edge or edge region 8, on which the extension pieces 13 are designed, runs along a rear edge or edge region 18 of the main wing 10.

In the example of embodiment of the flap 1 represented in FIGS. 1 to 3, which is coupled to a wing assembly, the extension pieces 13 are designed as an extension of what is the upper surface 18 with reference to a vertical axis of the aircraft, wherein the upper surface 18 of the flap 1 and the adjacent surface 17 of the extension pieces 13 form an aerodynamically continuous surface, i.e. a surface profile along which the flow S flows in an undisturbed manner. In this form of embodiment of the extension pieces 13 on the flap 1 of a wing assembly, the lowering of the flap 1 generates with reference to the aircraft vertical axis an elevation of the extension pieces 13 or vortex generators at an angle to the flow S. In general, and in particular in the case of a vertical arrangement of the wing and the flap 1, or in an arrangement of the flap 1 on a vertical tail assembly, pivoting of the flap 1 to a first side (in FIG. 3 the side S2) effects a pivoting of the extension pieces 13 or vortex generators to the second side situated opposed to this first side (in FIG. 3 the side 51).

The arrangement and configuration of the extension pieces 13 or vortex generators on the flap 1 is provided such that in a neutral flap position on the wing F or on a structural section the extension pieces 13 do not project into the flow and in particular into the boundary layer of the wing F or structural section, and only when the flap moves out of its neutral position are exposed to the mainstream flow on the side 51 of the wing or structural section, curved in a convex manner as a result of the flap deflection. In this state the vortex generators generate an aerodynamic vortex flow in accordance with the principle of a vortex generator, in which an energy-rich mainstream flow is mixed with the encumbered boundary layer flow near the surface. The extension piece 13 does not influence the flow on what, with a deflection of the flap 1, is the concave side S2 of the wing or structural section.

With the design of the flap 1 as a lateral rudder of a vertical tail assembly, the extension pieces 13 are provided such that when the lateral rudder is pivoted to either side S1, S2, opposed to one another relative to the neutral position, on the convex side S1 of the vertical tail assembly as shaped by the deflection of the flap 1 they thereby project into the flow in each case, and on the concave side S2 of the vertical tail assembly as shaped by the deflection of the flap 1 they are situated within the outer contour formed by the fin of the vertical tail assembly and the rudder on this side.

In general and in particular in the example of embodiment of a flap 1 as part of the vertical tail assembly of a design of lateral rudder each of the surfaces of the flap 1 situated opposed to one another can have the extension pieces 13, so that on both sides of the main wing, or structural section, or fin, the extension pieces 13 project into the flow, and thereby in each case on the concave outer side, so as to form the vortices provided in accordance with the invention.

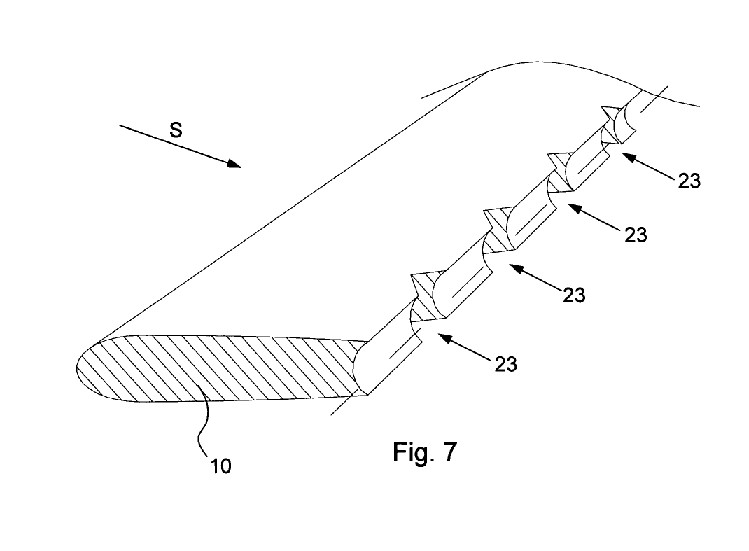

When the flap 1 is pivoted in the opposite direction the extension pieces 13 on the concave side in each case, as viewed in the cross-section of the wing F or structural section, are moved within its outer contour, if extension pieces 13 are attached to the concave side. To accommodate the extension pieces 13 of the wing F or structural section an appropriate recess is provided in the interior of the wing F or structural section. FIG. 7 shows an example of embodiment of the wing or structural section, in which for each extension piece 13 a recess 23 is designed, whose outer contour is matched in each case with the outer contour of the associated extension piece 13 with regard to a form fit interaction whilst enabling the extension parts 13 to move within the wing F or structural section. With the triangular configuration of the extension parts 13 the recesses 23 are similarly configured in triangular shapes in accordance with FIG. 7.

In particular the edge region 18 of the main wing 10 or structural section can be configured such that when flap 1 is in a neutral position these engage with one another in a form fit flush with the surface.

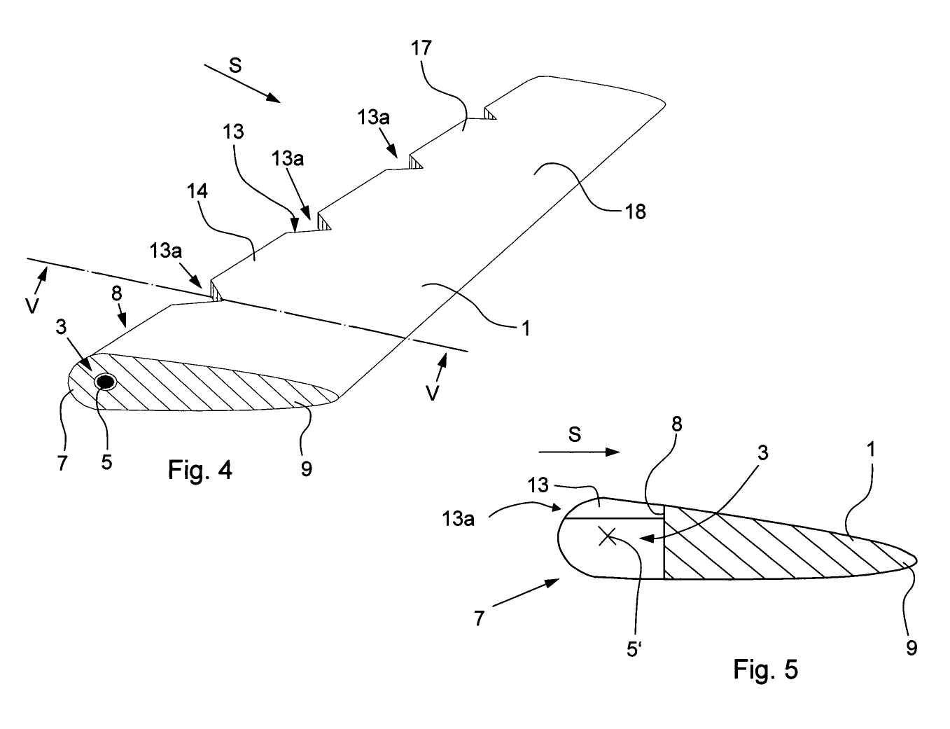

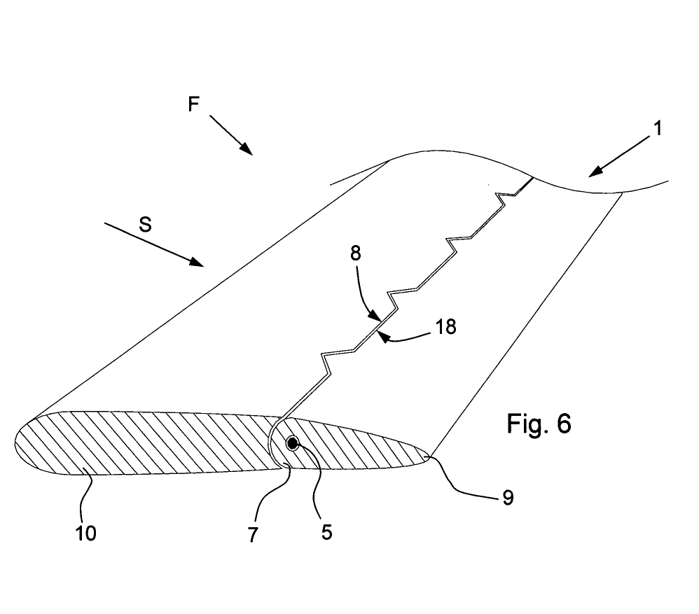

In particular, the vortex generators 13 can be implemented as a section projecting beyond the axis of rotation of the control surface and e.g. plate-shaped, which is part of the contour lying upstream of the axis of rotation 5, which has recesses 13a that are situated between the extension sections or extension pieces 13. These recesses 13a are formed as triangular-shaped indents in the representation of FIG. 4. These indents can also be formed as rectangular, or round, or curved, or otherwise shaped indents or recesses. The wing or structural section preferably has recesses that in particular can accommodate the extension pieces 13 in a form fit, such that the extension pieces or vortex generators can overlap the wing or structural section. Thus the extension pieces 13 in accordance with FIGS. 4 and 5 are longer in the spanwise direction than the indents or recesses, since the extension pieces 13 are formed as continuously overlapping extensions of the profile in the spanwise direction, which are interrupted by the recesses 13a. In the representation of FIG. 4 the overlap of the extension sections or extension pieces 13 over the axis of rotation 5 cannot be detected, since the front sectioned region represented in FIG. 4 is an edge region and in the example of embodiment represented the extension sections or extension parts 13 do not overlap over the whole width of the span.

The forms of embodiment of the extension pieces or vortex generators in accordance with the invention can also only be designed for some sections of the span width of the flap 1.

In general the flap 1 can overlap the edge region of the main wing or structural section determined by the rear edge line, as viewed against the direction of flow S. Alternatively or additionally provision can be made that the edge region of the main wing determined by the outer contour of the rear edge line of the main wing interacts in a form fit manner with the outer contour of the flap facing towards the main wing, at least when the flap is located in its neutral position.

1. An aerodynamic flap with an articulation device to form an axis of rotation for purposes of a rotatable coupling of the aerodynamic flap to a wing section or structural section, with the flap coupled in accordance with its intended purpose, with a front flap section situated upstream of the axis of rotation, as viewed in the flow direction, with a front edge line, and a rear flap section situated behind the axis of rotation, wherein
a multiplicity of extension pieces are arranged on the front flap section, distributed over the span width of the flap, whose ends project beyond the front edge line of the flap as exposed parts, as viewed from the axis of rotation, and
the extension pieces are rigidly arranged on the flap and designed such that one surface of the extension pieces, which extends in a planar manner, forms a planar prolongation of the upper or lower surface of the flap and thereby an aerodynamically uniform surface with the upper or lower side of the flap.

2. The aerodynamic flap in accordance with claim 1, wherein the extension pieces are distributed at regular intervals over the span width of the flap.

3. The aerodynamic flap in accordance with claim 1, wherein the exposed ends of the extension pieces are designed as triangular, rectangular or round sections.

4. A wing with a main wing and an aerodynamic flap, which is hinged to the main wing by means of an articulation device to form an axis of rotation for purposes of a rotatable coupling of the same, such that the flap has a front flap section situated in front of the axis of rotation, as viewed in the flow direction, with a front edge line, and a rear flap section situated behind the axis of rotation, wherein
a multiplicity of extension pieces are arranged on the front flap section, distributed over the span width of the flap, whose ends project as exposed parts beyond the front edge line of the flap, as viewed from the axis of rotation,
wherein the extension pieces are rigidly and arranged on the flap and designed such that one surface of the extension pieces, which extends in a planar manner, forms a planar prolongation of the upper or lower surface of the flap and thereby an aerodynamically uniform surface with the upper or lower side of the flap, and such that when the flap is deflected the exposed ends of the extension pieces on one surface of the flap are directed at an angle against the flow to generate vortices, and in a neutral position of the flap are situated underneath the boundary layer of the wing.

5. The wing in accordance with claim 4, wherein the extension pieces are distributed at regular intervals over the span width of the flap.

6. The wing in accordance with claim 4, wherein the exposed ends of the extension pieces are designed as triangular, rectangular or round sections.

7. The wing in accordance with claim 4, wherein the rear edge line of the main wing, at its rear running along the flap in a spanwise direction, runs such that the edge region of the main wing determined by the edge line has alternating extension pieces and recesses.

8. The wing in accordance with claim 7, wherein the flap overlaps the edge region of the main wing determined by the rear edge line, as viewed against the direction of flow.

9. The wing in accordance with claim 7, wherein the edge region of the main wing, determined by the outer contour of the rear edge line of the main wing, interacts in a form fit manner with the outer contour of the flap facing towards the main wing, at least when the flap is located in its neutral position.
